(19) United States
(12) Patent Application Publication
(10) Pub. No.: US 2003/0077109 A1
(43) Pub. Date: Apr. 24, 2003

(54) Joint structure of solid knockdown card

(75) Inventor: Sheng-Hsi Chen, Taipei (TW)

Correspondence Address: DOUGHERY & TROXELL, 5205 LEESBURG PIKE, SUITE 1404, FALLS CHURCH, VA, 22041, US

(73) Assignee: Chu-Yuan LIAO

(21) Appl. No.: 09/983,315

(22) Filed: Oct. 24, 2001

(51) Int. Cl. F16D 1/12; F16B 7/10; F16C 11/00

(52) U.S. Cl. 403/52

(57) ABSTRACT

Joint structure of knockdown card, including a main body and a first connecting section and a second connecting section respectively extending from two ends of the main body. A main card and several subsidiary cards of the knockdown card are formed with connecting sections corresponding to the first and second connecting sections. By means of connecting the connecting sections, the main card and subsidiary cards are assembled and can be relatively swung about the connecting sections so as to change the angle contained between the main card and subsidiary cards. The joint structure can be two-segment joint to achieve more mobile activity of the knockdown card.

### BACKGROUND OF THE INVENTION

The present invention is related to a joint structure applicable to 3D solid knockdown cards with patterns of humans, animals, aircrafts, cars, boats, mechanical articles, etc. The joint structure serves to connect the main card with subsidiary cards and change the angle contained therebetween so as to enhance the fun during assembly of the knockdown cards.

FIGS. 1 and 2 show a commercially available solid knockdown card assembly including a main card 10 and several subsidiary cards 11. The main card 10 and subsidiary cards 11 are formed with corresponding insertion notches 12 by which the subsidiary cards 11 can be assembled with the main card 10 to form a solid pattern. The main card 10 and subsidiary cards 11 are printed with brilliant colorful picture in accordance with the solid pattern. For example, in FIGS. 1 and 2, the solid knockdown card assembly has a form of a human in which the main card 10 is printed with a picture of a human body, while the subsidiary cards 11 are printed with pictures of hands and legs.

After assembled, the relative angles and positions of the main card 10 and subsidiary cards 11 are fixed due to the fixed insertion notches 12. The angle of the pattern cannot be adjusted so that the fun and liveliness of the knockdown card assembly are limited. Accordingly, such knockdown card assembly can be only rested as a decoration. Therefore, it is tried by the applicant to develop a joint structure of solid knockdown card, which adjoins the main card with the subsidiary cards and permits a player to freely adjust and vary the angle between the main card and subsidiary cards.

### SUMMARY OF THE INVENTION

It is therefore a primary object of the present invention to provide a joint structure of solid knockdown card, which enables a player to vary the angle contained between the main card and subsidiary cards. The joint structure includes a main body and a first connecting section and a second connecting section respectively extending from two ends of the main body. A main card and several subsidiary cards of the knockdown card are formed with connecting sections corresponding to the first and second connecting sections. By means of connecting the connecting sections, the main card and subsidiary cards are assembled and can be relatively swung about the connecting sections so as to change the angle contained between the main card and subsidiary cards and enhance the fun during assembly of the knockdown card.

It is a further object of the present invention to provide the above joint structure in which the main body is composed of a first retaining bar and a second retaining bar. One end of the first retaining bar is formed with a spherical head, while the other end thereof is formed with a connecting section. One end of the second retaining bar is formed with a socket corresponding to the spherical head for pivotally fitting therewith. The other end of the second retaining bar is formed with another connecting section. The connecting sections are connected with the main card and subsidiary cards and the spherical head is fitted into the socket, whereby the angle contained between the main card and subsidiary cards can be changed to enhance the fun and intelligence during assembly of the knockdown card.

The present invention can be best understood through the following description and accompanying drawings wherein:

### BRIEF DESCRIPTION OF THE DRAWINGS

FIG. 1 is a perspective exploded view of a conventional solid knockdown card;

FIG. 2 is a perspective assembled view of the conventional solid knockdown card;

FIG. 3 is a perspective view of a first embodiment of the joint structure of the present invention;

FIG. 4 is a perspective view of a second embodiment of the joint structure of the present invention;

FIG. 5 is a perspective exploded view of the solid knockdown card to which the joint structure of the present invention is applied;

FIG. 6 is a perspective assembled view of the solid knockdown card to which the joint structure of the present invention is applied;

FIG. 7 is a perspective exploded view of another embodiment of the joint structure of the present invention;

FIG. 8 is a perspective exploded view of the solid knockdown card to which the joint structure of the present invention is applied;

FIG. 9 is a perspective assembled view of the solid knockdown card to which the joint structure of the present invention is applied;

FIGS. 10 and 11 show the operation of the joint structure of the present invention; and

FIG. 12 is a perspective exploded view of another embodiment of the joint structure of the present invention.

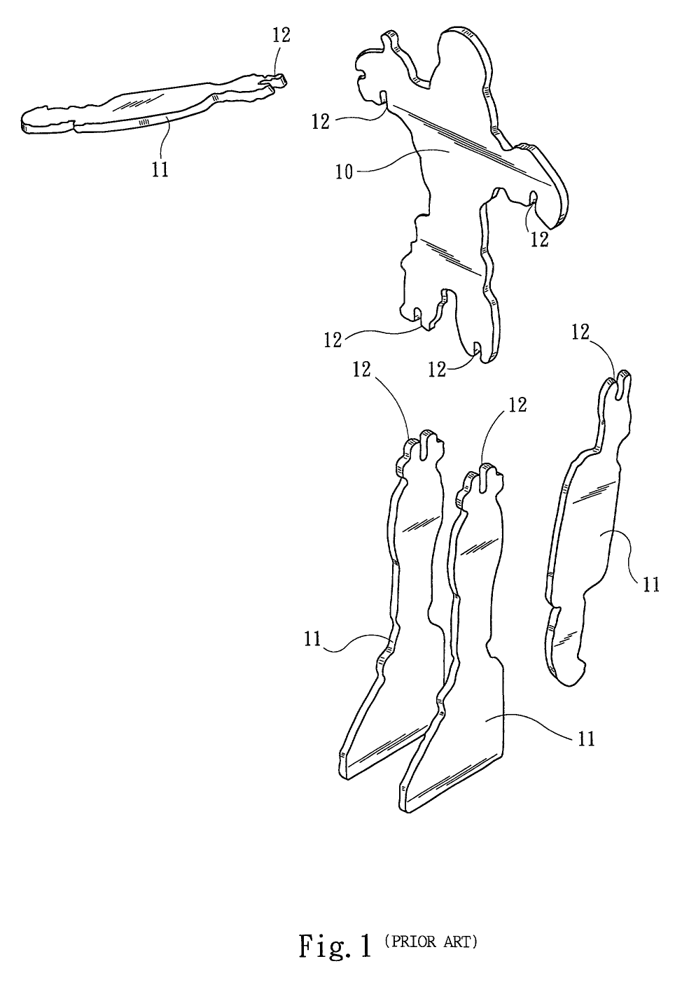

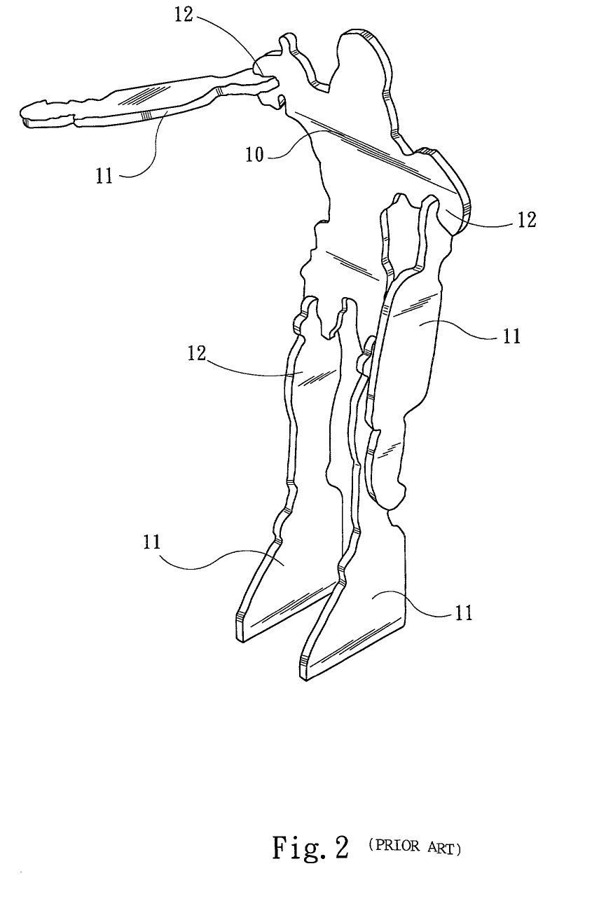

### DETAILED DESCRIPTION OF THE PREFERRED EMBODIMENTS

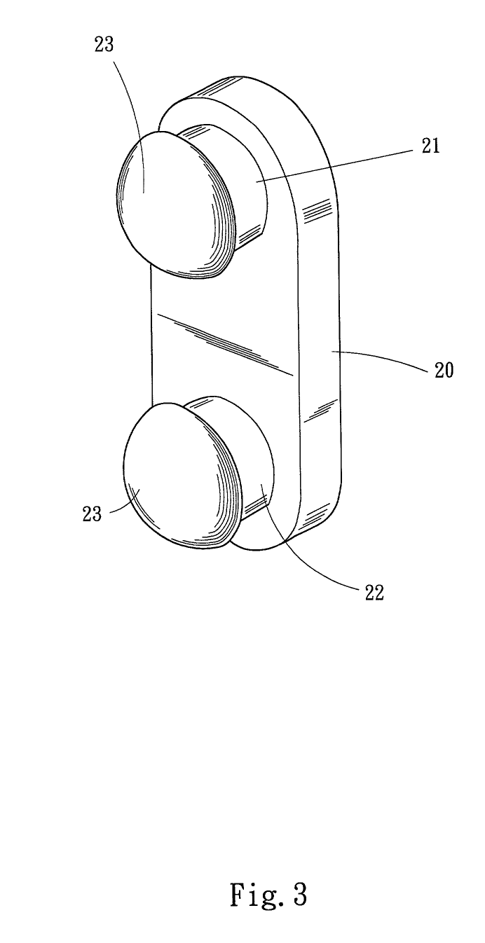

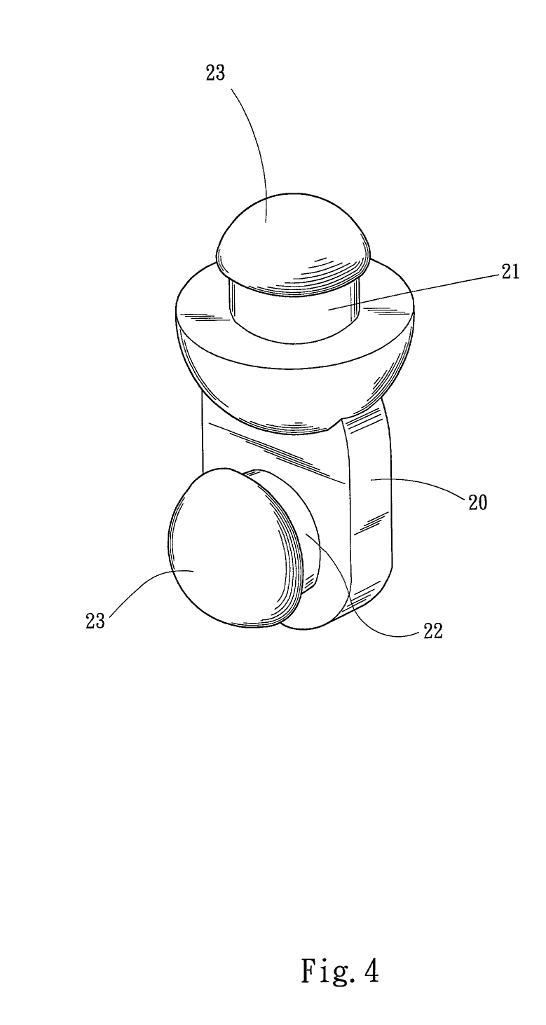

Please refer to FIGS. 3 and 4. The joint structure of knockdown card of the present invention has a main body 20 and a first and a second connecting sections 21, 22 extending from two ends of the main body 20. The first and second connecting sections 21, 22 can be parallel to each other or contain a certain angle. The free end of the each of the first and second connecting sections 21, 22 is formed with a fitting cap 23 with an outer diameter slightly larger than the connecting sections 21, 22.

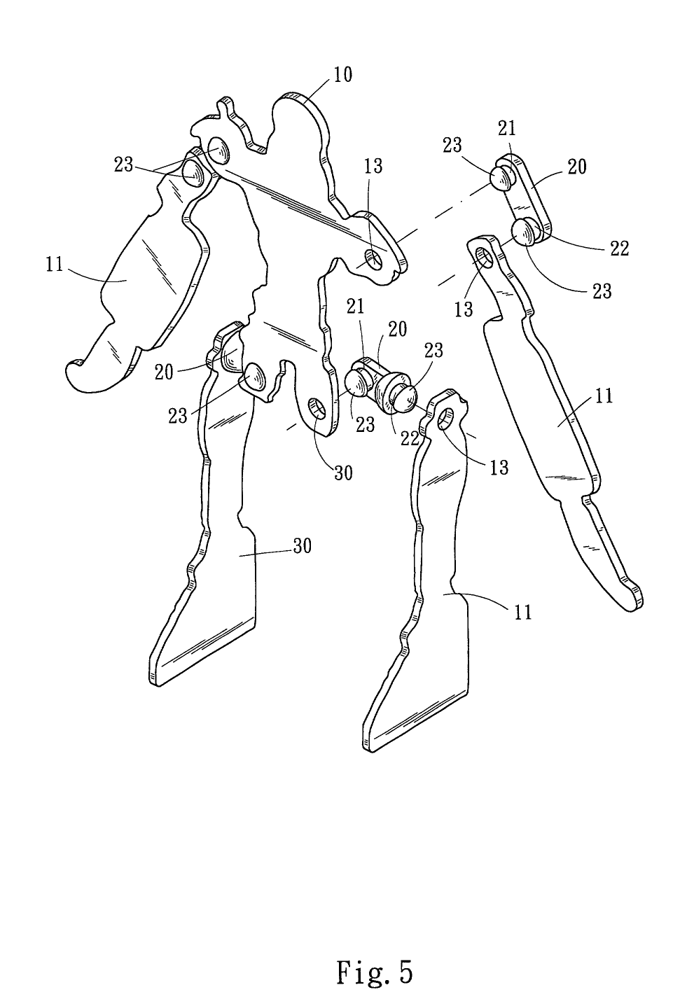

As shown in FIG. 5, the main card 10 and subsidiary cards 11 are all formed with connecting sections 13 corresponding to the connecting sections 21, 22. The diameter of the connecting section 13 is smaller than the outer diameter of the fitting cap 23, while being equal to or slightly smaller than the outer diameter of the connecting sections 21, 22. When assembling the main card 10 and subsidiary cards 11, the connecting section 13 is fitted with the connecting sections 21, 22 to form the solid pattern.

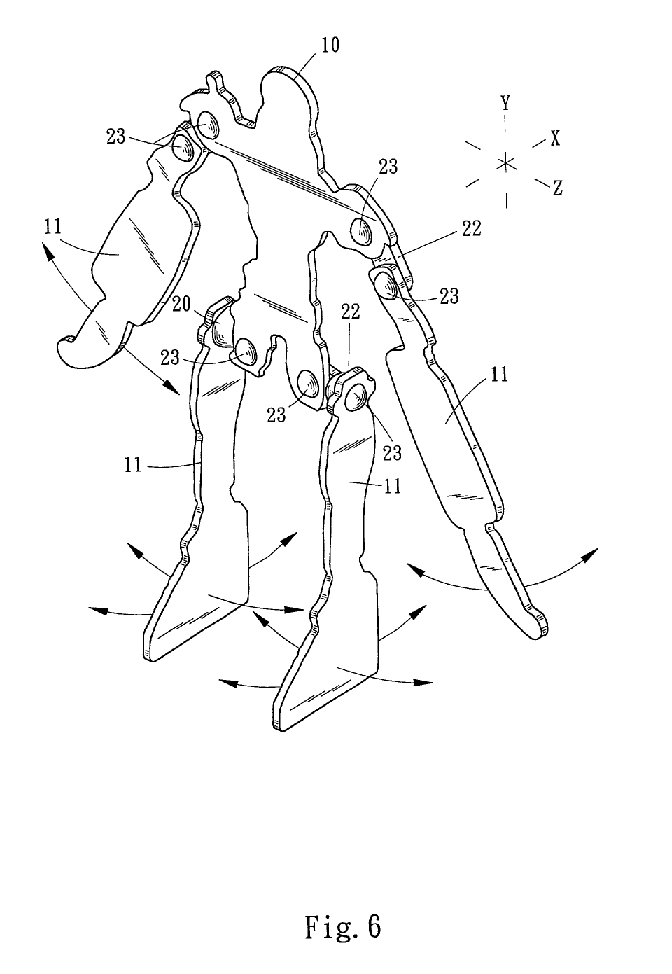

Referring to FIG. 6, the main card 10 and subsidiary cards 11 can be relatively swung about the connecting sections 21, 22. In the case that the main card 10 is assembled with the first connecting section 21, while the subsidiary card 11 is assembled with the second connecting section 22 and the second connecting section 22 extends along X axis, the subsidiary card 11 can be swung relative to the main card 10 in parallel to the YZ plane. The other cases are similar to the above case.

In addition, in accordance with various patterns such as humans, animals, insects, mechanical articles, etc., the first and second connecting sections 21, 22 can be parallel to each other or contain a certain angle.

Furthermore, after the connecting section 13 is fitted with the connecting sections 21, 22, the fitting cap 23 restricts the main card 10 and subsidiary cards 11 from easily detaching from each other.

The cross-section of the first and second connecting sections 21, 22 and the fitting cap can be circular, hexagonal, octagonal and so on without limitation to achieve the same object.

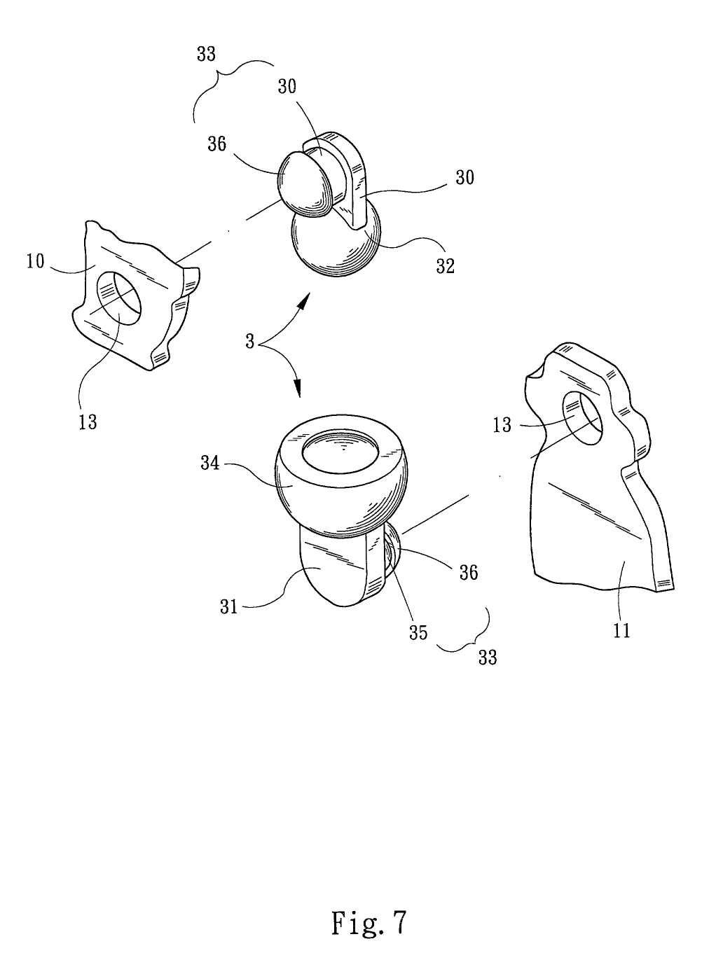

FIG. 7 shows another embodiment of the present invention, in which the main body 3 is composed of a first retaining bar 30 and a second retaining bar 31. One end of the first retaining bar 30 is formed with a multidirectional spherical pivot head 32, while the other end thereof is formed with a connecting section 33. One end of the second retaining bar 31 is formed with a multidirectional socket 34 (such as a socket with one side open) corresponding to the spherical pivot head 32 for fitting therewith. The other end of the second retaining bar 31 is formed with a connecting section 33. The connecting sections 33 serve to connect the main card 10 and subsidiary cards 11 of the solid knockdown card assembly.

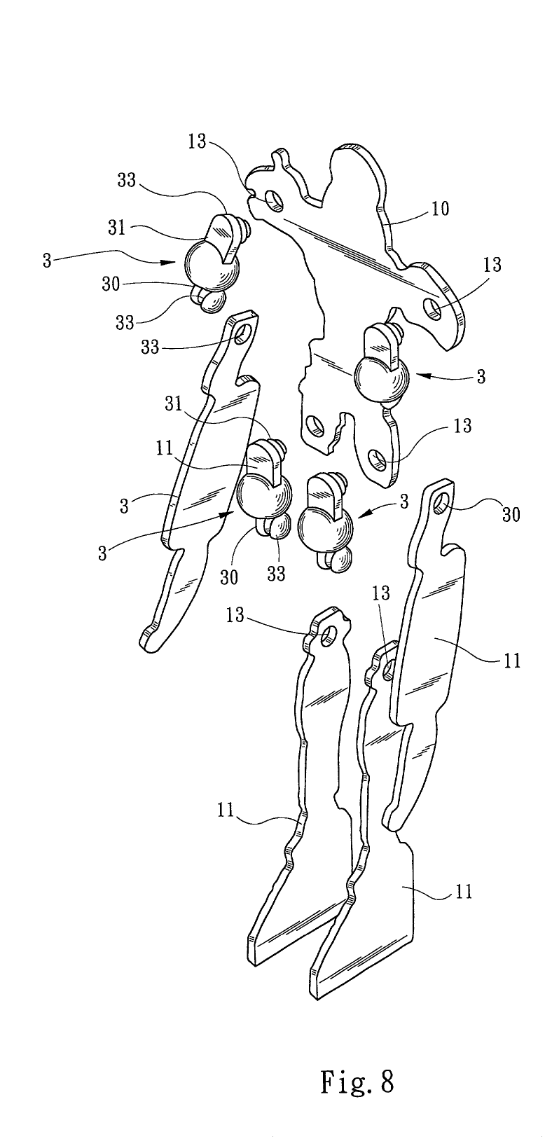

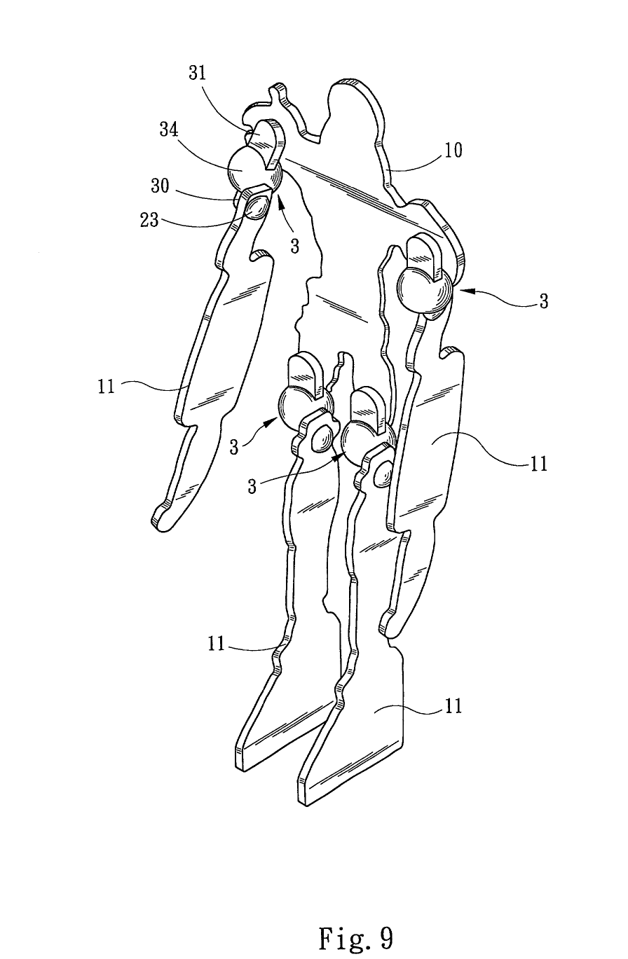

Referring to FIGS. 7, 8 and 9, the connecting section 33 has a neck section 35 extending from the retaining bar 30 (31). A fitting cap 36 is formed at the free end of the neck section 35 to form a mushroom-like connecting section 33. The main card 10 and the subsidiary cards 11 are formed with connecting sections 13 corresponding to the neck section 35 of the connecting section 33. The mushroom-like fitting cap 36 can be forcedly fitted into the connecting section 13 so as to assemble the main card 10 or the subsidiary card 11 with the retaining bar 30 (31) without easy detachment.

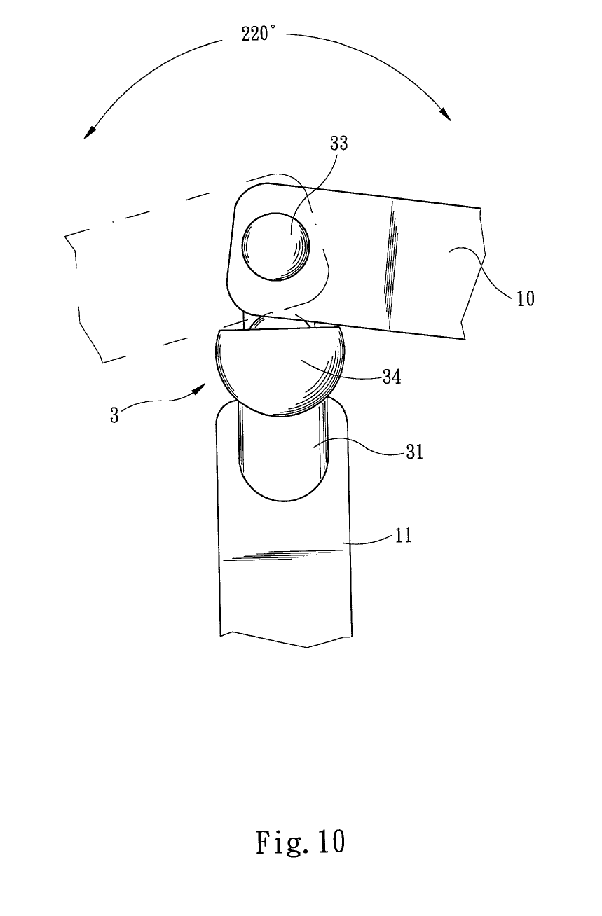

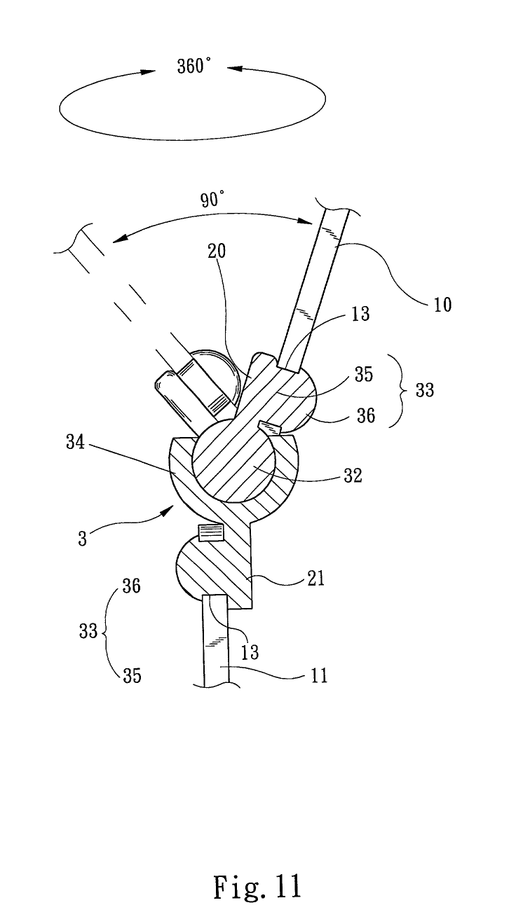

Referring to FIGS. 10 and 11, the first and second retaining bars 30, 31 can be relatively 360 degrees rotated and 90 degrees swung about the axis of the spherical pivot head 32 and the socket 34 so as to change the angle. Furthermore, the main card 10 or the subsidiary card 11 can be about 220 degrees swung left and right relative to the first or second retaining bar 30 or 31 about the connecting section 33. That is, after assembled, the angle between the main card 10 and subsidiary cards 11 of the solid knockdown card assembly of the present invention can be freely changed so as to enhance the fun.

The cross-section of the neck section 35 and the fitting cap 36 of the connecting section 33 can be circular, hexagonal, octagonal and so on without limitation to achieve the same object.

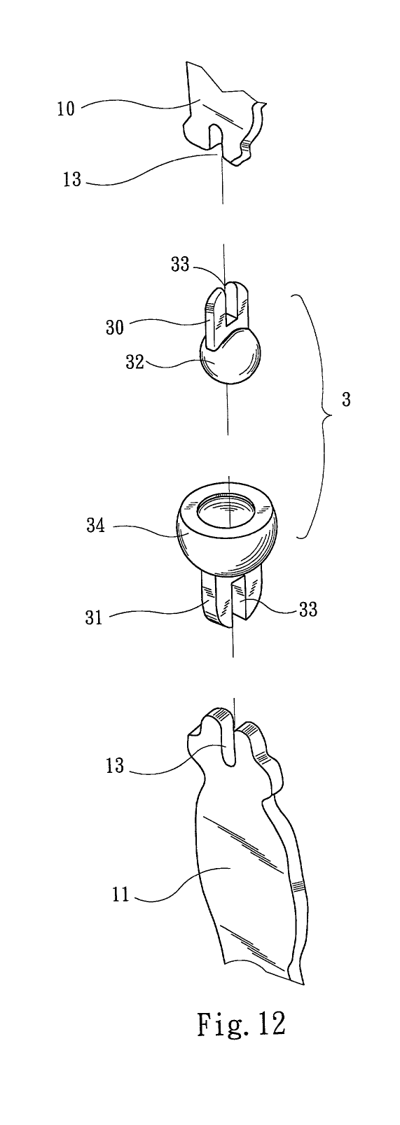

FIG. 12 shows still another embodiment of the present invention, in which the connecting sections 21, 22, 33 are designed as notches corresponding to the insertion notch 13 of the main card 10 or subsidiary card 11. The connecting sections 21, 22, 33 can be inserted with the insertion notches 13 to assemble the main card 10 or subsidiary card 11 with the joint structure of the present invention. By means of rotating the joint structure of the present invention, the angle between the main card 10 and subsidiary cards 11 can be changed.

With the variable angle between the main card 10 and subsidiary cards 11, the solid knockdown card assembly can be more lively. For example, in the case that solid knockdown card has a form of an animal, the angle between the limbs and the trunk can be varied to present various attitudes of the animal pattern. This enhances the fun and intelligence during assembly.

In the joint structure of solid knockdown card of the present invention, universal joint is applied to the knockdown card, whereby the main card and subsidiary cards can be swung by various angles to achieve more fun and liveliness.

The above embodiments are only used to illustrate the present invention, not intended to limit the scope thereof. Many modifications of the above embodiments can be made without departing from the spirit of the present invention.

What is claimed is:

1. Joint structure of knockdown card, comprising a main body and a first connecting section and a second connecting section respectively extending from two ends of the main body, a main card and several subsidiary cards of the knockdown card being formed with connecting sections corresponding to the first and second connecting sections, whereby the connecting sections can be connected with each other to assemble the main card and subsidiary cards to form a pattern of the knockdown card.

2. Joint structure of knockdown card as claimed in claim 1, wherein the first and second connecting sections are retaining shafts, while the connecting sections of the main card and subsidiary cards are through holes through which the retaining shafts are pivotally fitted.

3. Joint structure of knockdown card as claimed in claim 2, wherein a fitting cap is formed at a free end of the retaining shaft, the fitting cap having a diameter larger than the diameter of the through hole.

4. Joint structure of knockdown card as claimed in claim 3, wherein the cross-section of the retaining shaft and the fitting cap is polygonal.

5. Joint structure of knockdown card as claimed in claim 1, wherein the first and second connecting sections contain a certain angle.

6. Joint structure of knockdown card as claimed in claim 2, wherein the first and second connecting sections contain a certain angle.

7. Joint structure of knockdown card as claimed in claim 3, wherein the first and second connecting sections contain a certain angle.

8. Joint structure of knockdown card as claimed in claim 4, wherein the first and second connecting sections contain a certain angle.

9. Joint structure of knockdown card as claimed in claim 1, wherein the main body is composed of at least a first retaining bar and a second retaining bar, one end of the first retaining bar being formed with a multidirectional pivot section, while the other end thereof being formed with a connecting section, one end of the second retaining bar being formed with a multidirectional socket corresponding to the pivot section for pivotally fitting therewith, the other end of the second retaining bar being formed with another connecting section.

10. Joint structure of knockdown card as claimed in claim 9, wherein a neck section extends from the retaining bar of the connecting section, a fitting cap being formed at a free end of the neck section for fitting through a corresponding through hole of the main card or subsidiary card.

11. Joint structure of knockdown card as claimed in claim 10, wherein the cross-section of the neck section and the fitting cap of the connecting section is polygonal.

12. Joint structure of knockdown card as claimed in claim 9, wherein the connecting section is a notch for inserting with an insertion notch formed on the main card or subsidiary card.

13. Joint structure of knockdown card as claimed in claim 9, wherein the multidirectional pivot section is a spherical head, while the multidirectional socket is a socket with one side open.

14. Joint structure of knockdown card as claimed in claim 10, wherein the multidirectional pivot section is a spherical head, while the multidirectional socket is a socket with one side open.

15. Joint structure of knockdown card as claimed in claim 11, wherein the multidirectional pivot section is a spherical head, while the multidirectional socket is a socket with one side open.

16. Joint structure of knockdown card as claimed in claim 12, wherein the multidirectional pivot section is a spherical head, while the multidirectional socket is a socket with one side open.
